(19) United States
(12) Patent Application Publication
(10) Pub. No.: US 2016/0377721 A1
(43) Pub. Date: Dec. 29, 2016

(54) BEAT SIGNAL BANDWIDTH COMPRESSION METHOD, APPARATUS, AND APPLICATIONS

(71) Applicant: Mezmeriz Inc., Ithaca, NY (US)

(72) Inventors: Clifford A. Lardin, Ithaca, NY (US); Shahyaan Desai, Ithaca, NY (US); Scott G. Adams, Ithaca, NY (US)

(73) Assignee: Mezmeriz Inc., Ithaca, NY (US)

(21) Appl. No.: 15/193,279

(22) Filed: Jun. 27, 2016

Related U.S. Application Data
(60) Provisional application No. 62/185,014, filed on Jun. 26, 2015.

(51) Int. Cl. G01S 17/10; G01S 17/00; G01S 17/58; G01S 7/481

(52) U.S. Cl. CPC G01S 17/102; G01S 7/4817; G01S 17/003; G01S 17/58

(57) ABSTRACT

High-resolution laser range finding using frequency-modulated pulse compression techniques can be accomplished using inexpensive semiconductor laser diodes. Modern applications of laser range finding often seek to maximize the distance over which they can resolve range together with the range resolution and to minimize the pulse duration in order to acquire more data in less time. The combination of these requirements results in increasing bandwidth requirements for processing the ranging data, which can exceed 10 GHz over ranges of tens of meters, depending on the range resolution and pulse duration. Here we describe a method of compressing this range data bandwidth in real time using low-cost components and simple techniques that require no increase in processing time or resources.

### RELATED APPLICATION DATA

This application claims priority to U.S. provisional application Ser. No. 62/185,014 filed Jun. 26, 2015, the subject matter of which is incorporated by reference in its entirety.

### GOVERNMENT FUNDING

N/A.

### BACKGROUND

Aspects and embodiments of the invention are generally in the field of signal processing applied to range determination; more particularly relate to apparatus, systems, and associated methods for high-resolution laser range finding; and most particularly to methods and supporting apparatus and systems pertaining to real-time beat frequency bandwidth compression.

With new developments in self-driving cars, and capture of geometries for architectural, geological surveying, and construction applications, there is an increasing need for the ability to create accurate depth maps over a distance of 10-300 meters.

High-resolution laser range finding using frequency-modulated pulse compression techniques can be accomplished using inexpensive semiconductor laser diodes by exploiting the wavelength shift these devices undergo when injection current is modulated in a specific way. The resulting wavelength/frequency shift, also known as ‘chirp,’ is a wide-band frequency excursion from hundreds of MHz to hundreds of GHz centered around the laser diode's fundamental wavelength, which often is measured in hundreds of THz. This change in frequency can be accomplished in pulses as narrow as a few nanoseconds since these laser diodes are designed to be pulsed in the tens of GHz in digital telecommunication modes.

Since the technique of generating the frequency ‘chirp’ relies on the wavelength shift of the laser diode, small changes in injection current can produce relatively large changes in frequency excursion of the emitted laser energy.

Because the range accuracy of a linearly frequency modulated (LFM) pulse is proportional to the change in frequency, a large change in frequency is required for many ranging applications.

The range resolution (ability to distinguish between two simultaneous targets, or distance resolution of a single target) for a simple linear FM pulse compression ranging system is given by:

dR=c′/(2*dF), (Eq. 1)

where [c′] is the speed of light in air and [dF] is the bandwidth of the LFM pulse. For example, for a range resolution of one meter, only 150 MHz of dF is required. However, if a range resolution of one centimeter is desired, then 15 GHz of dF is required. Modern ranging systems suitable for real-time capture require sub-centimeter range resolution, requiring even greater dF.

The FM pulse-compression technique involves correlating a portion of the outgoing pulse with the light reflecting off the target; the result includes a beat frequency that is proportional to the round-trip delay to and from the target, which is proportional to the range to the target.

The relationship between the beat frequency and range is as follows:

bF=(dF/dT)*(2*D/c′), (Eq. 2)

where [dF] is the frequency excursion of the chirp within the LFM pulse, [dT] is the duration of the LFM pulse, [D] is the distance to the reflection source (target), and [c′] is the speed of light in air.

Furthermore, since the duration of the ‘beat’ is directly proportional to the interaction time between the outgoing pulse as well as the time the reflected echo takes to get back to the system, measuring targets further away requires longer outgoing pulses, which slows down the data/pixel acquisition rate of the system.

Tb=Tp−Te;

Te=2D/c′,

where Tb is the beat frequency duration, Tp is the LFM pulse width, and Te is the time it takes for a reflected signal from the target to reach back to the system, which is simply the distance to and from the target (2D) divided by the speed of light c′.

While it is desirable and straightforward to obtain relatively large dF over short dT using the current injection modulation method described above, the resulting beat frequency bandwidth also increases as dF/dT increases.

Ranging applications including real-time mapping, automotive sensing applications, 3D video capture, etc., require a high pixel rate, currently in excess of 1 million pixels per second. Since pixel rate is inversely proportional to pulse time (dT), these applications seek to maximize dF/dT within the bounds of beat frequency bandwidth processing capabilities and dT over D. However, as D increases, holding all else constant, beat frequency bandwidth increases linearly. This poses a significant challenge to system designers as sampling systems required to process the beat frequencies need to operate at least twice as fast as the highest frequencies being measured according to the Nyquist-Shannon information theorem. Sampling beat frequencies significantly higher than a few hundred MHz thus becomes impractical with conventional sampling electronics, and requires prohibitively expensive Analog to Digital sampling systems. For example, to resolve a single distance measurement to within 1 cm requires a dF of at least 15 GHz. To make 1 million such measurements within a second for real-time mapping applications results in a beat frequency that increases by 100 MHz/m according to eq. (2). A target at 10 meters or farther, would result in beat frequencies of >1 GHz, requiring an analog to digital sampling system operating at at least 2 GHz according the Nyquist sampling theorem to accurately measure the beat frequency and hence accurately determine the distance. Analog to digital sampling systems with sampling frequencies in excess of 2 GHz cost several thousands of dollars, making them prohibitively expensive. For the sake of discussion within this invention disclosure frequencies of 500 MHz or higher are considered to be ‘high’ frequencies.

Recognizing this challenge, it is desirable to reduce the beat frequencies produced by a ranging system to below 500 MHz. The invention disclosed within highlights a method and associated apparatus for reducing the large beat frequencies resulting from the measurement of far distance, so that they can be easily processed by inexpensive, off the shelf analog to digital sampling systems without any loss of range resolution or information regarding the distance

### SUMMARY

An aspect of the invention is a method for beat signal bandwidth compression. The method includes the steps of providing a first and at least a second frequency modulated laser distance measurement system, wherein the first and second systems each produce a high-frequency range determining beat signal for an object; electrically mixing the two high-frequency range determining beat signals to produce a low frequency beat differential signal, wherein the low frequency beat differential signal is used to determine the distance to the object. According to various exemplary, non-limiting aspects, the method may additionally include one or more of the following steps, components, assemblies, features, limitations or characteristics, alone or in various combinations as one skilled in the art would understand:
linearly sweeping an emission from the first frequency modulated laser detection subsystem over a first delta frequency range over a first delta time; linearly sweeping an emission from the second frequency modulated laser detection subsystem over a second delta frequency range over a second delta time, wherein a first ratio of the first delta frequency divided by the first delta time is not equal to a second ratio of the second delta frequency range divided by the second delta time;
   wherein the first delta frequency range is centered about a first center frequency; the second delta frequency range is centered about a second center frequency; and, the first center frequency and the second center frequency are different;
      wherein the first center frequency and the second center frequency are separated sufficiently such that the range of emission frequencies of the first frequency modulated laser detection system and the range of emission frequencies of the second frequency modulated laser detection system do not overlap;
   wherein the first ratio and the second ratio are adjusted based on the distance being measured;
   further comprising performing a first measurement, performing a second measurement, and using the first measurement and second measurement to determine both the distance to the object and the object's radial velocity; wherein performing the first measurement includes sweeping the first frequency modulated laser detection subsystem's emission linearly over a first delta frequency range over a first delta time thereby producing a first high-frequency range determining beat signal; sweeping the second frequency modulated laser detection subsystem's emission linearly over a second delta frequency range over a second delta time thereby producing a second high-frequency range determining beat signal; electrically mixing the resulting first and second high-frequency range determining beat signals to produce a low frequency beat differential signal A; wherein performing the second measurement includes sweeping a third frequency modulated laser detection subsystem's emission linearly over a third delta frequency range over a third delta time thereby producing a third high-frequency range determining beat signal; sweeping a fourth frequency modulated laser detection subsystem's emission linearly over a fourth delta frequency range over a fourth delta time thereby producing a fourth high-frequency range determining beat signal; electrically mixing the resulting two high-frequency range determining beat signals to produce a low frequency beat differential signal B; and, wherein using the first measurement and second measurement includes using the sum and difference of low frequency beat differential frequency A and low frequency beat differential frequency B;
wherein the two or more frequency modulated laser distance measurement systems include one or more frequency modulated laser distance measurement systems containing delay lines;
wherein the low frequency beat differential signal is below 500 MHz;
wherein the two high-frequency range determining beat signals are above 500 MHz.

An aspect of the invention is a LIDAR system. An exemplary LIDAR system includes two or more frequency modulated laser detection subsystems each simultaneously producing high-frequency range determining beat frequencies for an object, wherein the two or more separate high-frequency range determining beat frequencies are mixed electrically to produce one or more low frequency beat differential signals, wherein the one or more low frequency beat differential signals are used to determine the distance to the object. According to various exemplary, non-limiting aspects, the LIDAR system may additionally include one or more of the following components, assemblies, features, limitations or characteristics, alone or in various combinations as one skilled in the art would understand:
wherein each frequency modulated laser detection subsystem comprises a frequency modulated laser source that emits a beam; a splitter for splitting the beam into a detection beam and a local oscillator beam; a light directing unit for directing the detection beam toward an object; a collector that collects the reflection beam, wherein the reflection beam comprises a portion of the detection beam reflected from the object; a combiner that combines the local oscillator beam and the reflected beam; and a detector that detects the local oscillator beam and the reflected beam mix to form the high-frequency range determining beat frequencies;
   wherein each frequency modulated laser detection subsystem utilizes the same collector, combiner, and detector;
   wherein each frequency modulated laser detection subsystem utilizes the same collector;
      further comprising a subsystem splitter located after the collector, wherein the reflected beam is separated based on the respective frequency modulated laser detection subsystem;
         wherein the subsystem splitter comprises a emission wavelength filter;
         wherein the subsystem splitter comprises a polarization filter.

### BRIEF DESCRIPTIONS OF FIGURES

FIG. 1 graphically illustrates the embodied invention wherein the difference between bF[2][0 . . . n] (upper line)) and bF[1][0 . . . n] (middle line)) is bF[2]′[0 . . . n] (bottom line), which is a bandwidth-compressed representation of bF[2][0 . . . n] with a slope proportional to the difference of the two beat frequency lines, according to a non-limiting, exemplary aspect of the invention.

FIG. 2 schematically shows a two detector system according to an exemplary embodiment of the invention.

FIG. 3 schematically shows a single detector system according to an exemplary embodiment of the invention.

FIG. 4 schematically/graphically details the interactions of the various electrical and optical signals in accordance with the one detector embodiment, according to a comparative, illustrative embodiment of the invention.

FIG. 5 schematically/graphically details the interactions of the various electrical and optical signals in accordance with the two detector embodiment, according to a comparative, illustrative embodiment of the invention.

FIG. 6 schematically shows a multiple laser/detector system according to an exemplary embodiment of the invention.

FIG. 7 schematically/graphically shows an example combination of subsystems in terms of the resulting beat frequency as a function of distance according to an illustrative embodiment of the invention.

FIG. 8 schematically shows a three-beam detector system according to an exemplary embodiment of the invention.

FIG. 9 is a chirp frequency versus time graph illustrating the relationship between beat frequency, LFM pulse width, and time of flight according to an illustrative embodiment of the invention.

FIG. 10 is a graph of beat frequency as a function of distance-to-target with and without the effect of a delay line according to an illustrative embodiment of the invention.

### DETAILED DESCRIPTION OF EXEMPLARY, NON-LIMITING EMBODIMENTS OF THE INVENTION

Embodiments of the invention relate to apparatus and methods for beat frequency bandwidth compression.

### Relationship of Beat Frequency Bandwidths

High-resolution laser range finding using frequency-modulated pulse compression techniques can be accomplished using inexpensive semiconductor laser diodes by exploiting the wavelength shift these devices undergo when injection current is modulated in a specific way. The bandwidth required to process the resulting ranging data is proportional to the change in wavelength and the distance to the target, and inversely proportional to the pulse duration.

Modern applications of laser range finding often seek to maximize the distance over which they can resolve range together with the range resolution, which implies wide-band modulation; and to minimize the pulse duration in order to acquire more data in less time. The combination of these requirements results in increasing bandwidth requirements for processing the ranging data, which can exceed 10 GHz over ranges of 10's of meters, depending on the range resolution and pulse duration.

Techniques and components capable of processing such a large resultant bandwidth are complex and expensive. In this disclosure, I describe a novel method of compressing this range data bandwidth in real time using low-cost components and simple techniques that require no increase in processing time or resources.

High-resolution laser range finding using frequency-modulated pulse compression techniques can be accomplished using inexpensive semiconductor laser diodes by exploiting the wavelength shift these devices undergo when injection current is modulated in a specific way. The resulting wavelength shift is a potentially wide-band FM chirp anywhere from hundreds of MHz to hundreds of GHz centered around the laser diode's fundamental wavelength, which often measured in hundreds of THz. This change in frequency can be accomplished in pulses as narrow as a few nanoseconds since these laser diodes are designed to be pulsed in the 10's of GHz in digital telecommunication modes.

Because the range accuracy of an LFM pulse is proportional to the change in frequency, a large change in frequency is required for many ranging applications.

The range resolution (ability to distinguish between 2 simultaneous targets, or distance resolution of a single target) for a simple linear FM pulse compression ranging system is given by:

dR=c′/(2*dF)

where [c′] is the speed of light in air and [dF] is the bandwidth of the LFM pulse. For example, for a range resolution of 1 meter, only 150 MHz of dF is required. However, if a range resolution of 1 centimeter is desired, then 15 GHz of dF is required. Modern ranging systems suitable for real-time capture require sub-centimeter range resolution, requiring even greater dF.

The FM pulse-compression technique involves correlating a portion of the outgoing pulse with the light reflecting off the target; the result includes a beat frequency that is proportional to the round-trip delay to and from the target, which is proportional to the range to the target.

The relationship between the beat frequency and range is as follows:

Fb=(dF/dT)*(2*D/c′)

where [dF]=the bandwidth of the LFM pulse, [dT] is the duration of the pulse, [D] is the distance to the reflection source, and [c′] is the speed of light in air.

While it is desirable and straightforward to obtain relatively large dF over short dT using the current injection modulation method described above, the resulting beat frequency bandwidth also increases as dF/dT increases.

Ranging applications including real-time mapping, automotive sensing applications, 3D video capture, etc. require a high pixel rate, currently in excess of 1 million pixels per second. Since pixel rate is inversely proportional to pulse time (dT), these applications seek to maximize dF/dT within the bounds of beat frequency bandwidth processing capabilities and dT over D.

As D increases, holding all else constant, beat frequency bandwidth increases linearly.

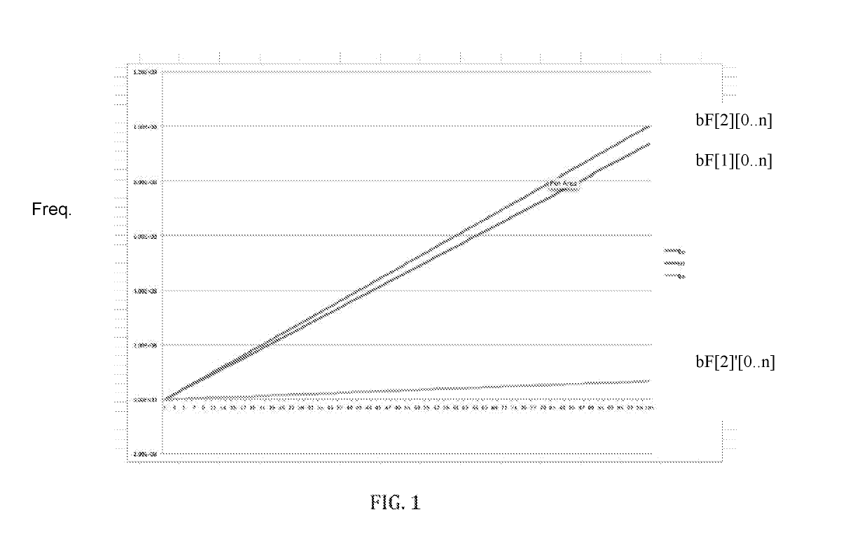

Since the beat frequency of an LFM pulse compression system as described above is proportional to measurement distance D and the ratio of dF/dT, it follows that holding D and dT constant but varying dF alone will produce a beat frequency that is proportional only to dF; that is, varying dF[1]<dF[2] for constant dT will produce a lower bF for a given D. It further follows that for a fixed range of D[0 . . . n] and a fixed dT, bF[1][0 . . . n] will all be lower than bF[2][0 . . . n] where bF[1] is the beat frequency corresponding to dF[1], and bF[2] is the beat frequency corresponding to dF[2]. Finally, as illustrated in FIG. 1, since range resolution is proportional to dF, the slope of the line connecting bF[1][0 . . . n] will be lower than the slope of the line connecting bF[2][0 . . . n]. The difference between bF[2][0 . . . n] (upper line)) and bF[1][0 . . . n] (middle line)) is bF[2]′[0 . . . n] (bottom line), a bandwidth-compressed representation of bF[2][0 . . . n] with a slope proportional to the difference of the two beat frequency lines.

Disclosed herein is a method of acquiring two or more beat frequencies for a given target simultaneously, and using theses beat frequencies in a heterodyne method to accomplish the embodied beat frequency bandwidth compression.

Semiconductor lasers emit coherent light in a narrow band around a central wavelength. Common wavelengths in use in mass-produced, inexpensive laser diodes designed for telecommunications applications include 1310 nm and 1550 nm. Many other center wavelengths can be used, and the embodied invention does not depend on this parameter.

It is possible to combine lasers of disparate wavelengths using optical components including beam splitters and mirrors, and since laser light of different wavelengths do not destructively interfere with one another, two or more such light sources can be directed at the same target simultaneously.

A system that includes laser diodes of two or more disparate center wavelengths may also be equipped with multiple optical detectors, one for each laser diode, where each detector is preceded by an optical filter allowing only one of the center wavelengths to reach the detector. Thus, each laser diode may be modulated differently, but also simultaneously, and reflections from the target detected simultaneously by different detectors, all without interference from the others.

Accordingly, by way of example, light from a 1310 nm laser with dF[1] can be combined in a collinear fashion with light from a 1550 nm laser with dF[2], where dF[1]<dF[2] as described above. Both dF[1] and dF[2] are modulated using an FM pulse compression technique over an identical time interval dT, and emitted simultaneously toward target T at distance D. The resulting beat frequencies bF[1] and bF[2] will differ in proportion to dF[1]/dF[2]. The beat frequencies are electrical oscillations generated as the output of optical detectors, such as Si, Ge, or InGaS photodiodes. It follows that bF[1] and bF[2] can be combined in an RF mixer, which results in bF[2]-bF[1] and bF[2]+bF[1] as the output. After a suitable LPF, only bF[2]-bF[1] remains, and it can be seen that the 1310 nm laser with dF[1] has been used to mix down bF[2] from the 1550 nm laser with dF[2]. Clearly, then, if this technique is used in a system that is sampling targets of a large range in D, the resulting beat frequency bandwidth will be reduced proportional to dF[1]/dF[2].

The use of a one or more frequency-modulated chirp lasers to generate a beat that is then used to heterodyne a primary frequency-modulated chirp laser beat should be capable of being bypassed or otherwise disabled in a ranging system as needed, without degradation of the desired primary ranging data. Further, the relationship between the way the primary ranging laser is driven (e.g., in dF/dT) and how one or more secondary lasers are driven, should be variable. For example, a potential limitation of the beat frequency bandwidth compression method described above might arise in the presence of noise distorting the compressed ranging data that exhibits a lower separation between discrete beat frequencies corresponding to increments in range as given by the range resolution for a given dF/dT due to its decreased slope. Thus, if the system detects that range resolution is insufficient (e.g., for nearby targets where maximum resolution is desirable), the relationship between dF[1] and dF[2] can be adjusted to increase the slope of bF[2]′, and therefore enable the desired resolution. This can be a continuously variable process, or a function of D, or any other pattern of operation.

### Exemplary Two Detector System and Associated Method Embodiment

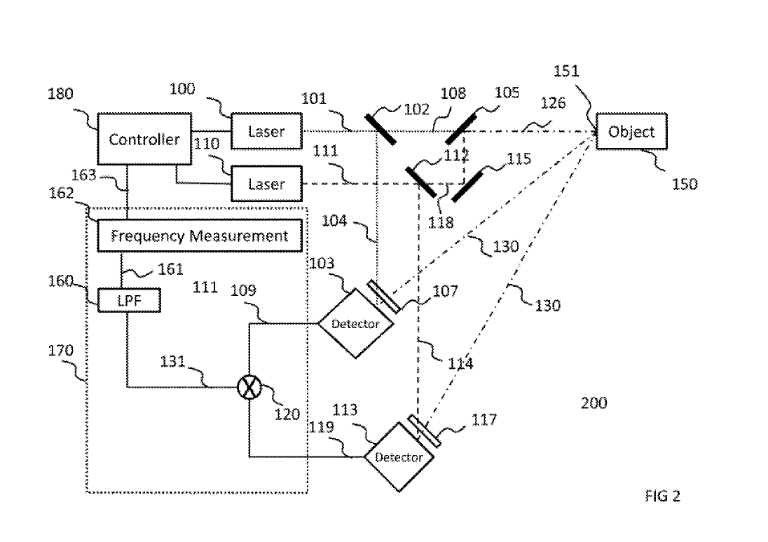

In a two-detector system 200 and associated method embodiment as illustrated in FIG. 2, a first laser 100 produces coherent beam 101. Coherent beam 101 strikes beam splitter component 102, which produces first local oscillator beam 104 and first detection beam 108. A parallel subsystem contains a second laser 110 that produces coherent beam 111. Coherent beams 101 and 111 have wavelengths that are modulated in time over a range of wavelengths; i.e., they are chirped. Coherent beam 111 strikes beam splitter component 112, which produces second local oscillator beam 114 and second detection beam 118. First detection beam 108 continues and passes through splitter 105, while second detection beam 118 reflects off mirror 115 and at splitter 105 combines with first detection beam 108 to form combined detection beam 126.

Although not shown, additional polarizers and quarter wave plates, common components to one skilled in the art of optical design, are used to combine first detection beam 108 and second detection beam 118 in a manner such that when combined with first local oscillator beam 104 and second local oscillator beam 114 at the respective detector surfaces, the two light sources mix and produce electrical beat signals 109, 119. For two optical sources to mix at a detector surface, the polarization of each source must be aligned, or nearly aligned. The reference point of the apparatus for distance measurements to object 150, for the purpose of discussion is the location where detection beam 108 and 118 combine at splitter 105. The purpose of combining the beams into combined detection beam 126 is to simultaneously measure the distance from the apparatus to the same spot on the same object at the same time.

Combined detection beam 126 is projected to object 150 at spot 151. At spot 151, combined detection beam 126 will be diffusely reflected over the exposed hemisphere to the left (in the drawing view) of object 150. Portions of the reflected light that reach detectors 103 and 113 are indicated by reflected light 130.

As drawn in FIG. 2, minor differences exist between the path lengths from first laser source 100 to object 150 and from second laser source 110 to object 150. Likewise, minor differences exist between the path lengths from object 150 to detector 103 and detector 113. Such minor differences can be accounted for in calibration of the apparatus.

Coherent beams 101 and 111 are similar in that they have wavelengths that are modulated in time (chirped); however, their respective center wavelengths differ. Since their center wavelengths differ, filters 107 and 117 can be placed over the detectors 103 and 113, respectively, such that only spectral portions of combined detection beam 126 that originated from first and second detection beams 108 and 118 strike detectors 103 and 113, respectively, via reflected beams 130. Optical mixing then occurs on detector 103 with only coherent light originating from first laser 100; likewise, optical mixing then occurs on detector 113 with only coherent light originating from second laser 110.

As an example, coherent beam 101 could emit wavelengths that are modulated over a range of wavelengths centered at 1308 nm, while coherent beam 111 could emit wavelengths that are modulated over a range of wavelengths centered at 1310 nm. As another example, one with much larger separation in wavelengths, coherent beam 101 could emit wavelengths that are modulated over a range of wavelengths centered at 1310 nm while coherent beam 111 could emit wavelengths that are modulated over a range of wavelengths centered at 1550 nm. Separation between the wavelength centers facilitates the filtering (filters 107, 117) that precedes each detector.

As a result of the optical mixing on detectors 103 and 113, respective electrical beat signals 109 and 119 result. Each beat signal has a component with a high-frequency beat frequency. From the value of these beat frequencies, the distance between the apparatus and object 150 can be determined.

To process the high-frequency beat signals into a distance measurement, beat signals 109 and 119 are mixed electrically at mixer 120 to produce beat difference signal 131. As an example, beat signal 109 might contain a component with a beat frequency on the order of 10 GHz and beat signal 119 might contain a component with a beat frequency at approximately 5% less, i.e., 9.5 GHz. By mixing the two beat signals, beat difference signal 131 results with an advantageously significantly lower frequency component at 500 MHz, 500 MHz being the difference between 10 GHz and 9.5 GHz and referred to as the beat difference frequency.

After mixing beat signal 109 and beat signal 119 at mixer 120, beat difference signal 131 contains frequency components with a variety of frequencies higher than the beat difference frequency, which are of insignificant value for the embodied invention. These higher frequencies can be filtered as indicated in FIG. 2 using low pass filter (LPF) 160. A filtered signal 161 results. From filtered signal 161, frequency measurement block 162 determines frequency information 163 containing the frequency of the filtered beat difference frequency, frequency information 163 being a measure of the distance between the apparatus and the object 150.

To one skilled in the art of circuit design, it is commonly known that there are a variety of techniques that can be used to determine the beat difference frequency within the filtered beat difference signal 161. For example, the filtered beat difference signal 161 could be sampled with an analog to digital converter (ADC) circuit and then processed in a digital signal processor (DSP) to perform a fast Fourier transform (FFT). Alternatively, the signal could be fed into a phased locked loop (PLL) architecture, wherein the control voltage on the internal voltage controlled oscillator is sampled as a measure of the frequency. Generally, the signal processing involved in mixing, filtering, and determining frequencies based on the electrical signals from the detectors will be referred to as the signal processing block 170.

Controller 180 receives frequency information 163 and together with the settings used in modulating the wavelengths of first laser 100 and second laser 110, determines the distance to the object 150 (see equ. (2)).

### Exemplary One Detector System and Associated Method Embodiment

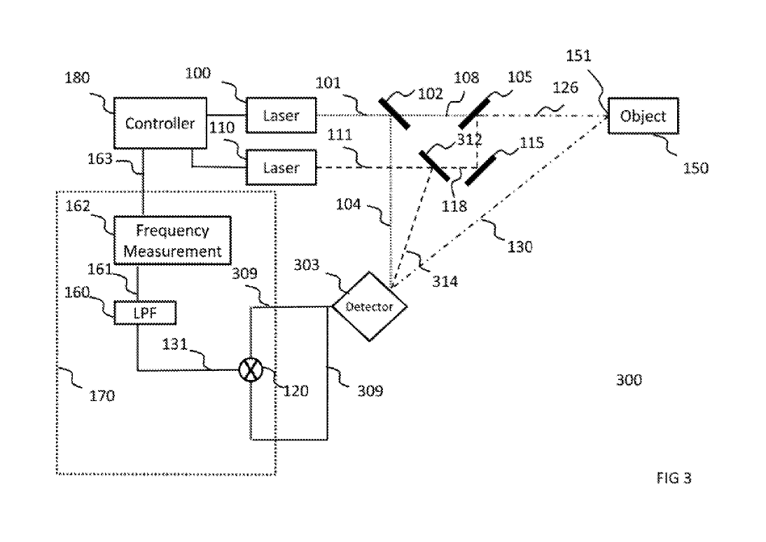

As illustrated in FIG. 3, another system and associated method embodiment utilizes a single detector instead of a pair of detectors as detailed in FIG. 2. FIG. 3 shows such a single detector system 300. In this example embodiment, combined detection beam 126 is formed in the same manner as in the two detector embodiment described above. Coherent beams 101 and 111 have wavelengths that are modulated in time over a range of wavelengths (chirped), but their respective center wavelengths differ. Furthermore, their center wavelengths differ sufficiently such that their respective chirp bandwidths do not overlap.

Where the system/method 300 starts to differ from system/method 200 is in the treatment of the local oscillator beams. First local oscillator beam 104 is split at splitter 102 as before and directed at detector 303, whereas second local oscillator beam 304 split from coherent beam 111 at splitter 312 is now directed at detector 303.

First and second local oscillators 104 and 304 mix with object reflected light 130 at the surface of detector 303. Since reflected light 130 contains different frequency portions of coherent beam 101 and coherent beam 111, four optical signals are mixing at the surface of detector 303; however, since the center wavelengths of coherent beams 101 and 111 differ sufficiently, the primary mixing process that produces range determining beat frequencies is unaffected. Higher frequency components are produced where light originating from coherent beam 101 and coherent beam 111 interact; however, these are secondary mixing effects that can be electrically filtered. Also note that detector 303 is not preceded optically by any wavelength filters as was the case in the two-detector embodiment. None is needed since the center wavelength separation provides the necessary segregation of frequencies to produce the range determining beat frequencies; however, in general detectors 103, 113, and 303 may have optics preceding the photoreceptive surface in order to collect light over a larger area than that of the photoreceptive surface.

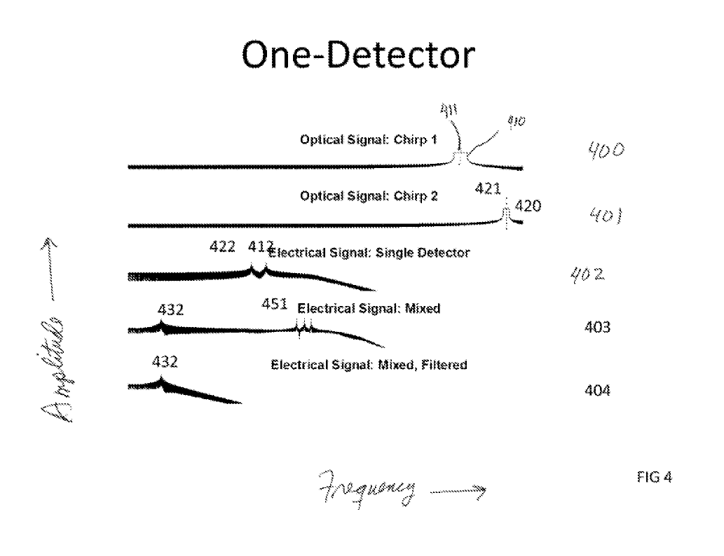

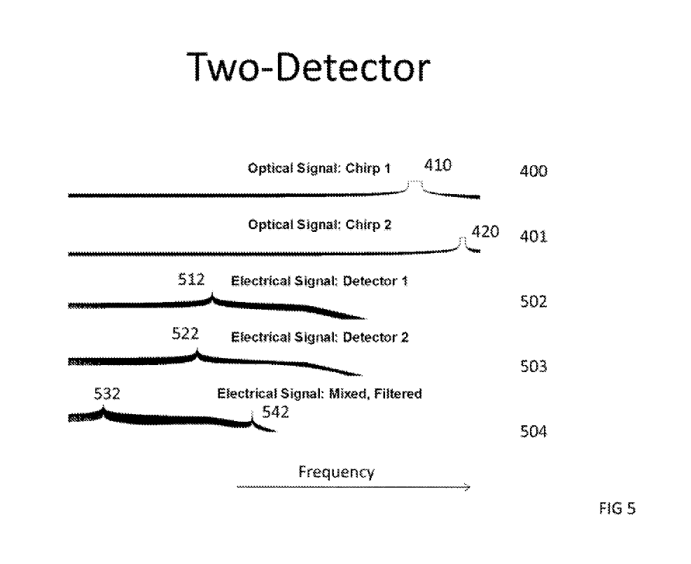

FIG. 4 details the interactions of the various electrical and optical signals in accordance with the example one detector embodiment. In addition, for comparison, FIG. 5 details the interactions of the various electrical and optical signals in accordance with the two detector embodiment. The vertical axis of FIG. 4 is amplitude in arbitrary units. The horizontal axis is frequency. Each signal is separated vertically to avoid overlapping signals. Each signal is enumerated with a general indication of signal 400 through signal 404.

Signal 400 shows the amplitude versus frequency of the coherent beam 101. Chirp component 410 shows the range of frequencies which correspond to the range of wavelengths over which the coherent beam 101 is modulated in time. Center frequency 411 corresponds to the center of the range of wavelengths. Likewise, Signal 401 shows the amplitude versus frequency of the coherent beam 111. Chirp component 420 shows the range of frequencies that correspond to the range of wavelengths over which the coherent beam 111 is modulated in time. Center frequency 421 corresponds to the center of the range of wavelengths.

Before going on to the mixing process in the one detector case, it is helpful to review the mixing process in the two detector case, where only the optical signals from one laser mix on any one detector. Referring to FIG. 5, signals 400 and 401 show the amplitude versus frequency of the coherent beam 101 and coherent beam 111, respectively, as in FIG. 4. In the two detector embodiment, when first local oscillator beam 104 and the reflected light 130 mix at detector 103, signal 502 results. Signal 502 is beat signal 109 of FIG. 2. When chirp component 410 within first local oscillator beam 104 mixes with the chirp component 410 within reflected light 130, beat frequency 512 results. Higher frequency components are also produced, but the electrical system is unable to resolve them.

In the two detector embodiment, when second local oscillator beam 114 and the reflected light 130 mix at detector 113, signal 503 results. Signal 503 is beat signal 119 of FIG. 2. When chirp component 420 within local oscillator beam 114 mixes with the chirp component 420 within reflected light 130, beat frequency 522 results.

In the two detector embodiment (FIGS. 2, 5), when beat signal 109 and beat signal 119 are mixed by mixer 120, beat difference signal 131 results. Signal 504 illustrates beat difference signal 131 after passing the signal through a low pass filter. Due to the mixing process, one expects sums and differences of frequencies to result. Beat difference frequency 532 is the difference between beat frequency 512 and beat frequency 522. Frequency 542 is the sum of beat frequency 512 and beat frequency 522. Low pass filtering is carried out in order to make the beat frequency 532 component the most dominant component of the signal for later frequency measurements.

In the single detector embodiment (FIGS. 3, 4), as indicated previously, four signals mix at the surface of detector 303: first local oscillator beam 104, second local oscillator beam 314, and components of coherent beam 101 and coherent beam 111 within reflected light 130. Since the center wavelengths of coherent beam 101 and coherent beam 111 differ sufficiently, the primary mixing process that produces range determining beat frequencies is unaffected. Beat frequency 412 and beat frequency 422 result from the optical mixing at detector 303 and are shown in signal 402. Beat frequency 412 is at the same value as beat frequency 512 (FIG. 5). Beat signal 422 is at the same value as beat frequency 522 (FIG. 5).

As shown in FIG. 3, the beat signal 309 output from detector 303 is mixed with itself in mixer 120. Beat difference signal 131 results and is illustrated in FIG. 4 generally by signal 403. Beat difference 432 results in the one-detector embodiment which occurs at the same frequency as beat difference frequency 532 in the two-detector embodiment. A collection of sums of beat frequencies occur as indicated by 451. Frequencies 451 are filtered by the low pass filtering that occurs in the signal processing that follows with LPF 160 resulting in filtered beat difference signal 161 also shown as 432 in signal 404 in FIG. 4.

The beat difference frequency 432 within the filtered beat difference signal 161 is determined by frequency measurement block 162, thereby producing frequency information 163 that is a measure of the distance between the apparatus and the object 150.

### Exemplary Multiple Detector System and Associated Method Embodiments

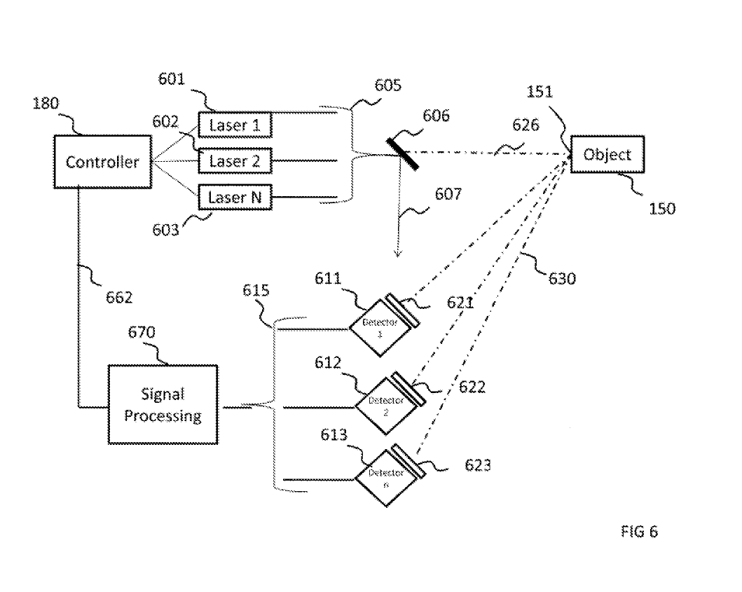

In light of the one and two-detector embodiments, it should be apparent that a variety of other combinations of lasers and detectors is possible. As shown in FIG. 6, the emission from more than two lasers can be combined into one combined beam 626. Emission from laser 601, 602, and 603 are combined into combined beam 626 using optical assembly 605. Generalized splitter 606 is used to split off local oscillator collection 607 for later optical mixing at the optical detectors 611, 612, and 613. Also split off from splitter 606 is the detection beam 626 used to measure the distance to object 150 from the reflected light 630 off of spot 151. Reflected light 630 strikes all of the detectors 611, 612, and 623 and can be processed in a variety of ways to handle multiple situations including the following examples:

1) Short and medium range measurements,
2) Medium and long range measurements at similar resolution, but different duration
3) Medium and long range measurements at varying resolution; and,
4) Faster simultaneous measurements of distance and velocity.

For short distance measurements, the method of beat signal bandwidth compression may not be necessary because the resulting beat frequency would be sufficiently low to process, i.e. determine the frequency of the beat frequency; however, one does not necessarily know the distance to an object a priori. For this reason, it may be advantageous to combine multiple laser range finding subsystems into one system for simultaneously handling multiple situations.

In one embodiment designed to cover short and medium range measurements, laser 601 and detector 611 could be designed for short range measurements, while lasers 602 and 603 and detectors 612 and 613 could be designed for medium range measurements. The short range measurements could be handled with the single-laser, single-detector using the common frequency modulated continuous wave (FMCW) distance measurement technique, while the medium range measurements could be handled with the dual-laser, dual-detector configuration using the beat frequency bandwidth compression technique.

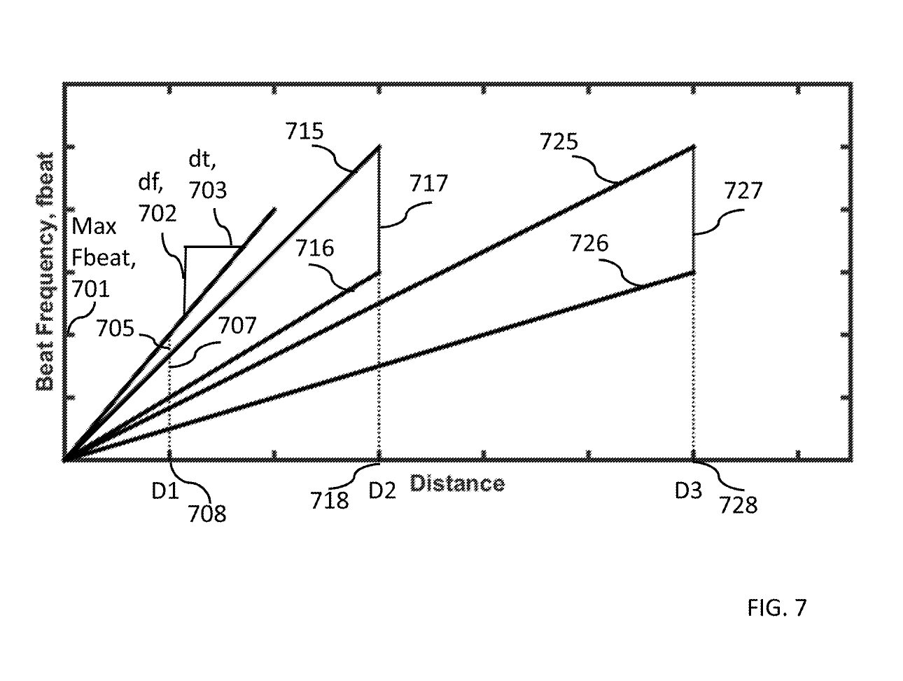

In accordance with the embodiment designed to handle short and medium range measurements, FIG. 7 shows an example combination of subsystems in terms of the resulting beat frequency as a function of distance. Laser 601 could be modulated over a frequency range df1 and over a time period dT yielding the beat frequency response 705. Assuming that the signal processing electronics are unable to process beat frequencies above max frequency 701, one could only measure out to a distance 708. For the medium distances, laser 602 and laser 603 could be modulated over a frequency range dF2 and frequency range dF3, respectively. Lasers 602 and 603 could be modulated over their respective frequency ranges over the same time period dT as laser 601 is modulated. When modulated in the manner, beat frequency responses 715 and 716 result. Using the beat frequency bandwidth compression method, the difference in beat frequencies is what would ultimately limit the distance 718 that can be measured. At distance 718, the beat difference frequency 717 equals the max frequency 701.

In this embodiment designed to handle short and medium range measurements, since the modulation times are the same and only the frequency ranges differ, the resolutions of the short and medium range measurements will differ. As the resolution equation states (see equ. (1), resolution is inversely proportional to the frequency range of the modulation. Therefore, in this example embodiment, the medium range measurements will have a lower resolution than the short range measurements. This need not be the case, but there is always a trade-off. If the resolutions were roughly equivalent, the medium range measurements would have steeper beat frequency responses with distance. At some point the mixers used to mix the two beat signals may limit the distance that one can process as indicated generally in FIG. 7 as max mix frequency.

In another embodiment, one that is designed to accommodate medium and long range measurements, measurements can be performed at varying distances, but at equivalent resolutions as determined by the resolution equation. Consider the system shown in FIG. 6, but with two additional lasers and two additional detectors. If the additional lasers are modulated over the same frequency range dF2 and frequency range dF3 as lasers 602 and 603 are modulated, then the resolution of the resulting distance measurement would be the same. In order to accommodate a greater range of distances, the two additional lasers would be modulated over the same frequency ranges as lasers 602 and 603, but over twice the time, dT. The beat frequency responses 725 and 726 would result from the mixing of their respective local oscillator beams and the combined reflected beam from the target on the detectors.

The beat difference frequency 727 would not reach the max frequency 701 until distance 728. Furthermore, this configuration would allow distance 728 to be measured with the same resolution as distance 718 would be measured.

The main point to be stressed is that with multiple lasers and detectors, one can perform short, medium, and long distance measurements at the same time. If the measurement turns out to be a short distance measurement, the single-laser, single-detector subsystem will find the distance with the most accuracy. If the measurement turns out to be a medium distance measurement, both the medium and the long distance subsystems will determine the distance 718, but the former will perform the measurement in half the time. At the medium distance, the single-laser, single detector subsystem will fail to measure the distance 718. If the measurement turns out to be a long distance measurement, only the long distance subsystem will be able to measure the distance 728.

Taking twice the time to perform a longer range measurement, but at equivalent resolution to shorter range measurements, may not be an option for certain applications. In an alternative embodiment to the prior embodiment designed to accommodate medium and long range measurements, the modulation times dT are kept equivalent for all of the distance measurement subsystems and only the dF's are varied. An identical set of beat frequency responses as shown in FIG. 7 could result. The only difference would be that the lower the slopes of each response would correspond to lower resolution measurements, i.e., the longer range measurements would have lower resolution.

In another embodiment, both the distance to the object and the object's radial velocity with respect to the laser source can be determined at the same time. Typically, the object's radial velocity is determined using two laser modulations, one with an increasing wavelength with time (i.e., up-chirp), and one with a decreasing wavelength with time (i.e., down chirp). Alternatively an up-chirp and a down-chirp can be combined into a single triangle wave. Due to the Doppler shift associated with the object's radial velocity, the beat frequencies that result from the increasing wavelength modulation and the decreasing wavelength modulation will differ. It is well known that the difference in beat frequencies are a measure of the radial velocity while the average of the beat frequencies are a measure of the distance to the target. By utilizing two lasers and two detectors, one laser-detector pair could be configured for the increasing wavelength modulation with time, while the other laser-detector pair could be configured for the decreasing wavelength modulation with time. By separating the center wavelengths of the two lasers and placing the appropriate filters over each detector, one could prevent the two subsystems from interacting, yet allow the subsystems to simultaneously measure the components that, when combined, determine both the distance and the radial velocity of the object. Effectively, both distance and velocity could be measured in the same time as in a single-laser, single-detector system that employs a combined up-chirp and down-chirp waveform in a single pulse window, but with the added complexity of additional laser(s) and detector(s).

In performing a distance measurement using LFM techniques, the laser source is typically chirped linearly in wavelength/frequency over a chirp period of time and over a chirp bandwidth, dF. To prevent mixing interactions at the detector between successive chirps, one can introduce an additional period of time where the laser is turned off. Other methods are possible for preventing interactions between successive pulses.

The systems and methods described herein provide enhanced methods of determining the distance to an object with improved resolution and speed and decreased electronics complexity necessary within the electronics used to determine the range determining beat frequency. Everything described herein so far has been a measurement between a reference point within the apparatus and some point out in space. Determining the distance along one linear path away from an apparatus is useful, but not as useful as being able to determine the distance to a grid of points distributed over a field of view. The scanning apparatus necessary to accomplish scanning a detection beam over a field of view is described in co-pending application entitled, “Portable Panoramic Laser Mapping and/or Projection System” application Ser. Nos. 14/753,937, 14/747,832.

Local oscillators 104 and 114 can be delivered to the detectors using a variety of techniques—free space or fiber optics. FIGS. 2, 3, and 6 suggest free space optics; however, in another embodiment, fiber optics could be used as a means of beam delivery for both the local oscillator and detection beams. For example, fiber coupled lasers, can be used with a fused or evanescent wave 1×2 fiber optic splitter to create the local oscillator and detection beams. The local oscillator carrying fiber can then be coupled to one input leg of a 2×2 fiber optic combiner, while the fiber carrying the detection beam is coupled to port 1 of a 3-port fiber optic circulator. Port 2 of the circulator is connected to a telescopic imaging system that directs the detection beam onto the target object, and simultaneously collects the reflected portion of the detection beam from the target and directs this reflected light into port 3 of the circulator, where it is coupled into the second leg of the 2×2 fiber optic combiner. The 2×2 fiber optic combiner delivers the local oscillator beam and the reflected detection beam simultaneously onto the surface of a coupled photodetector, where the optical mixing of the 2 signals results in a beat frequency. In many ways this facilitates the delivery of one or more local oscillators to the one or more detectors. Furthermore, one could also incorporate delay lengths of fiber optic cables in between the splitting optics and the detectors to enable longer range measurements.

One skilled in the art of circuit design will recognize that additional components may be necessary to signal process the beat signals in order to determine the beat difference frequency of the beat differential signals. Specifically, a low noise amplifier (LNA) may be necessary in between the detector(s) and each leg of the mixer. Additional components may be necessary to accomplish the functions described in the signal processing block; however, they would be known to one skilled in the art.

In the signal processing blocks shown in FIGS. 2, 3, and 6, one may choose to include additional switches in order to bypass the mixing process. In effect, bypassing the mixing process would allow one to process the optical signals using standard FMCW distance measurement techniques wherein a single beat frequency is determined within a single beat signal for the determination of distances.

In the two-detector embodiments, filters are placed over the detectors. These filters segregate the optical signals such that only components from a single laser source mix on each detector. It is possible to segregate the optical signals using polarization rather than wavelength separation. Furthermore, it is possible to even segregate the optical signals using polarization when only one detector is used.

In one two-detector embodiment that utilizes polarization, each laser source could be chirped with the same or differing center wavelength. Prior to combining the laser source emissions into a detection beam, the emissions of the two sources should be orthogonally polarized. By placing the corresponding polarization discriminating optics over the detectors, only the emissions that originate from the corresponding laser source will make it to each detector.

In the one-detector embodiment that utilizes polarization, each laser source could be chirped with the same or differing center wavelength. Just as in the two-detector case that utilizes polarization, prior to combining the laser source emissions into a detection beam, the emissions of the two sources should be polarized orthogonally with respect to each other. Given the optical mixing process that naturally occurs at the photoreceptive surface of a detector, only those optical components with the same polarization will mix efficiently; therefore, since each source polarized 90 degrees with respect to the other, only the emissions that originate from the corresponding laser source will mix on the detector surface.

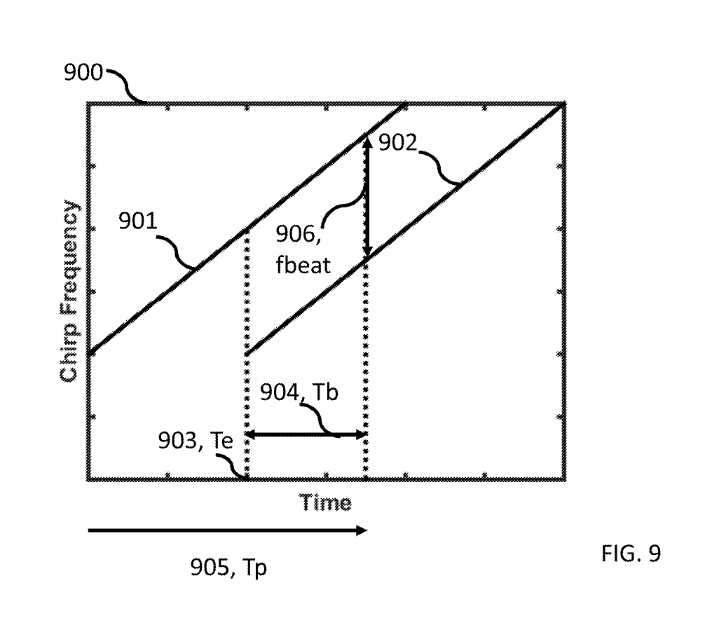

The relationship between the beat frequency, the LFM pulse width, and the time of flight for the reflection echo are detailed in FIG. 9 using the chirp frequency versus time graph 900. Line 901 shows the frequency of the outgoing chirp versus time. If the center wavelength for this chirp is approximately 1310 nm, the corresponding center frequency would be approximately 229 teracycles/sec (THz). The frequency excursion of the chirp about 229 THz could be 15 GHz, for example.

The reflected chirp signal is represented in FIG. 9 by line 902 which is equivalent to line 901 except shifted in time 903, i.e., Te, the time it takes for a reflected signal to travel to the target and back to the system. Time 904, i.e., Tb, is the duration of time that the beat frequency will be produced. Time 905, i.e., Tp, is the LFM pulse width.

Signal processing to extract the beat signal and thereby determine the distance to the target must take place during time 904. Intuitively, one can see in FIG. 9 that as the distance increases (i.e., longer transit time for reflection), the higher the beat frequency 906 that will result. Furthermore, one can also see that the longer the transit time, the less time (time 904, i.e., Tb) one has to signal process the resultant beat signal.

It is desirable for the system to be able to acquire data at high rates and over long distances in automotive applications, where such sensors may be employed for collision avoidance or autonomous control. The embodied invention discloses a method whereby a single system can scan targets at both near and far distances simultaneously. Instead of elongating or increasing the duration of the outgoing pulse, the system employs a setup whereby the outgoing beam is divided into three optical paths.

The majority of the laser energy is transmitted towards the target along one path as the detection beam. A small fraction of the laser energy is diverted towards a first PIN photodetector for the first local oscillator beam such that mixing or cross-correlation between the diverted laser energy from the outgoing laser pulse and reflected light from nearby targets occurs to produce a first beat frequency. Another small fraction of the laser energy similar in magnitude to that in the second optical path is transmitted towards a second PIN photodetector, through an optical delay line, such as a fiber optic cable of predetermined length, to form a second local oscillator beam that is delayed in time from the first local oscillator beam before mixing occurs with the reflected echo signal on the surface of the second PIN photodetector.

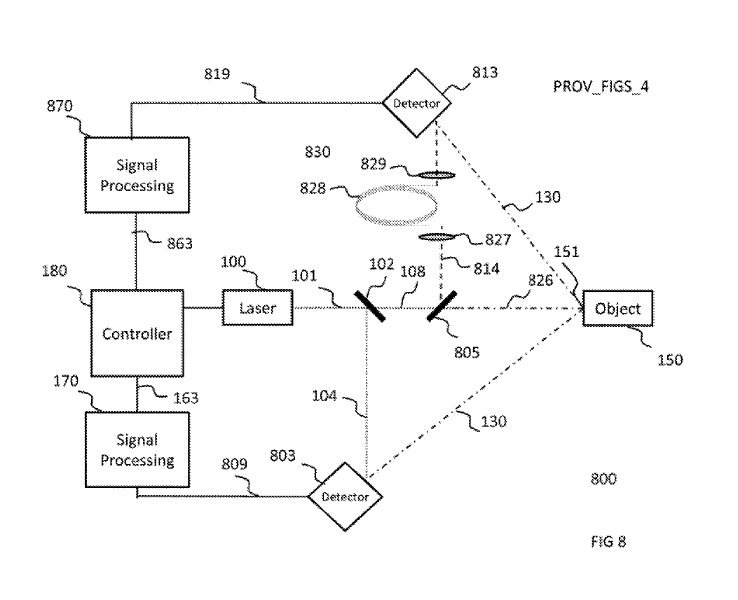

An example of such a system is shown in FIG. 8 and generally indicated by apparatus 800. Laser 100 outputs emission 101 which is first split at splitter 102 wherein most of the emission continues as beam 108 and the remaining portion is diverted to first local oscillator beam 104 and routed to first detector 803. Beam 108 is split a second time at splitter 805 wherein most of the emission continues on as detection beam 826 and the remaining portion is diverted to second local oscillator beam 814. Second local oscillator 814 is intentionally delayed using delay line 830 which, as an example, is comprised of three optical components: lens 827 to focus second local oscillator into fiber optics, fiber optic cable 828 which delays the local oscillator signal, and outgoing lens 829 which routes the delayed second local oscillator signal to second detector 813. Fiber optic cable 828 is designed to delay the second local oscillator by an amount of time equivalent to the round trip time required for light to travel a prescribed distance, e.g., 330 nanoseconds, which corresponds to a 50 m distance-to-target, which is equivalent to a delay of 100 m. One skilled in the art of optics design will recognize that one needs to account for the index of refraction of the fiber optic cable medium in designing the length of fiber needed.

Detection beam 826 strikes the target represented as object 150 at point 151 and reflects as reflected light 130 in a more diffuse manner than the original detection beam. For this reason, reflected light 130 will strike both first detector 803 and second detector 813. At each detector, the respective local oscillators will optically mix with reflected light 130 and thereby produce first beat signal 809 and second beat signal 819.

In terms of the beat duration time, Tb, the addition of an optical delay line has a similar effect in increasing the beat duration time as elongating the outgoing pulse duration, since the laser light along the third optical path takes longer to reach the second detector than the light along the first optical path. This in effect delays the time at which mixing occurs between the echo signal and the portion of the outgoing laser pulse. By precisely adjusting the length of the optical delay line, this effective mixing time delay can be set such that the detector observes targets beyond a certain distance away identically to the detector without an optical delay line. For example, with an equivalent delay of 100 m targets between 50-100 m, would appear to produce beat frequencies as if they were present within a 50 m radius. In this way the system can be made to ‘see’ targets at both near and far distances simultaneously without the need to modify the outgoing laser pulse duration.

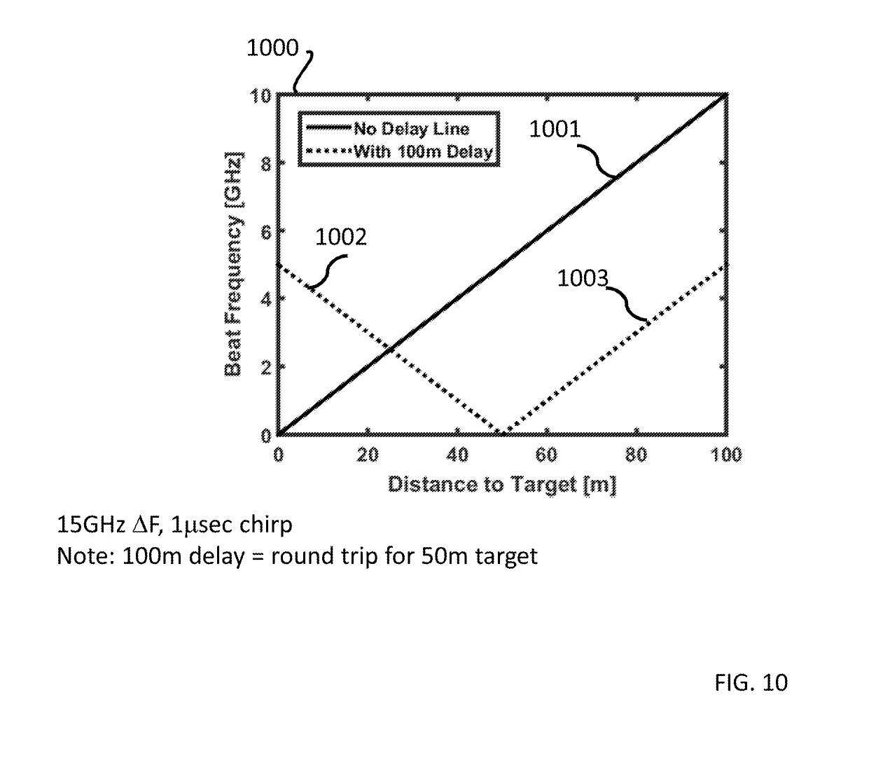

The beat frequency component of the first and second beat signals is detailed in FIG. 10 by graph 1000, which is a graph of the resulting beat frequency as a function of distance-to-target with and without the effect of the delay line. Line 1001 is the beat frequency component within beat signal 809 as a function of distance-to-target. Note that beyond 50 m, the resulting beat frequency will exceed 5 GHz. At some frequency level, e.g., frequency level 1002, the design of the signal processing electronics to extract the beat frequency from the beat signal will become prohibitively difficult or expensive. Furthermore note that at 50 m, only 0.66 μsec of an example 1 μsec chirp duration will produce a beat signal with a beat frequency. This reduction in time wherein a beat signal will be produced may not be problematic; however, as systems are designed with shorter and shorter chirp durations for faster measurements, eventually this limits increases in measurement speed.

Adding the example optical delay equivalent to 100 m (to and from 50 m) produces the beat frequency within the second beat signal 819 as shown by bilinear line 1003. From 0 to 50 m, the reflection arrives at the detector mostly before the delayed second local oscillator arrives. Second beat signal 819 has a high beat frequency component that decreases until the 50 m mark, at which point the reflection arrives at the same time as the local oscillator arrives. From then on, it is just as if a 0-50 m measurement is being performed as the beat frequency increases again.

An additional beneficial side effect of adding an optical delay to the second detector is that the bandwidth of generated beat frequencies remains low enough to be measured with inexpensive off the shelf RF and sampling electronics components. Beat frequency bandwidths for both detectors can be made to be identical such that instead of having separate signal processing circuits for each optical path, a single signal processing front-end can be employed.

One skilled in the art of optics design will recognize that the delay line 830 could be accomplished with a range of other components to accomplish the same task. Whatever components are used the local oscillator beam must be delayed by a designed amount.

The beat signal bandwidth compression method reduces the bandwidth over which a beat frequency needs to be determined. This method becomes more and more necessary as the distance to the object being measured increases. Likewise, extended range methods that use delay lines also provide bandwidth compression for long distance measurements; furthermore, extended range methods increase the beat signal duration in which a beat frequency is produced thereby improving the signal-to-noise ratio for measurements. Combining the two methods together can further extend the distances that can be measured by reducing the signal processing bandwidth requirements and improving the signal-to-noise ratio. From the methods and systems presented, it is a simple extension to combine beat signal bandwidth compression subsystems and extended range subsystems into one long range measurement system. In short, in the exemplary multiple detector system, by adding additional detectors, local oscillator splits, delay lines, and signal processing in accordance with the extended range method, one could combine beat signal bandwidth compression with extended range methods into one system.

In all of the embodiments described, additional optical components such as polarizers, quarter wave plates, lenses, polarizing beam splitters, and non-polarizing beam splitters may be necessary to complete the designs; however, these components are well known to those skilled in the art of optics design. In addition, there are many alternatives to accomplish the same function. In the end, the optical emissions need to be combined into a detection beam with the proper starting polarizations such that they can mix as described on the photoreceptive surfaces of one or more detectors. Just preceding detector's photoreceptive surfaces, additional optical components such as polarizers, quarter-wave plates, beam splitters, and lenses may be necessary to complete the design. In the end, the optical emissions that need to optically mix must have the same or mostly similar polarization.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

We claim:

1. A beat signal bandwidth compression method comprising:
providing a first and at least a second frequency modulated laser distance measurement system, wherein the first and second systems each produce a high-frequency range determining beat signal for an object;
electrically mixing the two high-frequency range determining beat signals to produce a low frequency beat differential signal, wherein the low frequency beat differential signal is used to determine the distance to the object.

2. The beat signal bandwidth compression method of claim 1, further comprising:
linearly sweeping an emission from the first frequency modulated laser detection subsystem over a first delta frequency range over a first delta time;
linearly sweeping an emission from the second frequency modulated laser detection subsystem over a second delta frequency range over a second delta time, wherein a first ratio of the first delta frequency divided by the first delta time is not equal to a second ratio of the second delta frequency range divided by the second delta time.

3. The beat signal bandwidth compression method of claim 2, wherein:
the first delta frequency range is centered about a first center frequency;
the second delta frequency range is centered about a second center frequency; and,
the first center frequency and the second center frequency are different.

4. The beat signal bandwidth compression method of claim 3, wherein the first center frequency and the second center frequency are separated sufficiently such that the range of emission frequencies of the first frequency modulated laser detection system and the range of emission frequencies of the second frequency modulated laser detection system do not overlap.

5. The beat signal bandwidth compression method of claim 2, wherein the first ratio and the second ratio are adjusted based on the distance being measured.

6. The beat signal bandwidth compression method of claim 2, further comprising performing a first measurement, performing a second measurement, and using the first measurement and second measurement to determine both the distance to the object and the object's radial velocity;
wherein performing the first measurement includes:
sweeping the first frequency modulated laser detection subsystem's emission linearly over a first delta frequency range over a first delta time thereby producing a first high-frequency range determining beat signal;
sweeping the second frequency modulated laser detection subsystem's emission linearly over a second delta frequency range over a second delta time thereby producing a second high-frequency range determining beat signal;
electrically mixing the resulting first and second high-frequency range determining beat signals to produce a low frequency beat differential signal A;
wherein performing the second measurement includes:
sweeping a third frequency modulated laser detection subsystem's emission linearly over a third delta frequency range over a third delta time thereby producing a third high-frequency range determining beat signal;
sweeping a fourth frequency modulated laser detection subsystem's emission linearly over a fourth delta frequency range over a fourth delta time thereby producing a fourth high-frequency range determining beat signal;
electrically mixing the resulting two high-frequency range determining beat signals to produce a low frequency beat differential signal B; and,
wherein using the first measurement and second measurement includes:
using the sum and difference of low frequency beat differential frequency A and low frequency beat differential frequency B.

7. The beat signal bandwidth compression method of claim 1, wherein the two or more frequency modulated laser distance measurement systems include one or more frequency modulated laser distance measurement systems containing delay lines.

8. The beat signal bandwidth compression method of claim 1, wherein the low frequency beat differential signal is below 500 MHz.

9. The beat signal bandwidth compression method of claim 1, wherein the two high-frequency range determining beat signals are above 500 MHz.

10. A LIDAR system, comprising:
two or more frequency modulated laser detection subsystems each simultaneously producing high-frequency range determining beat frequencies for an object, wherein the two or more separate high-frequency range determining beat frequencies are mixed electrically to produce one or more low frequency beat differential signals, wherein the one or more low frequency beat differential signals are used to determine the distance to the object.

11. The LIDAR system of claim 10, wherein each frequency modulated laser detection subsystem comprises:
a frequency modulated laser source that emits a beam;
a splitter for splitting the beam into a detection beam and a local oscillator beam;
a light directing unit for directing the detection beam toward an object;
a collector that collects the reflection beam,
wherein the reflection beam comprises a portion of the detection beam reflected from the object;
a combiner that combines the local oscillator beam and the reflected beam; and
a detector that detects the local oscillator beam and the reflected beam mix to form the high-frequency range determining beat frequencies.

12. The LIDAR system of claim 11, wherein each frequency modulated laser detection subsystem utilizes the same collector, combiner, and detector.

13. The LIDAR system of claim 11, wherein each frequency modulated laser detection subsystem utilizes the same collector.

14. The LIDAR system of claim 13, further comprising a subsystem splitter located after the collector, wherein the reflected beam is separated based on the respective frequency modulated laser detection subsystem.

15. The LIDAR system of claim 14, wherein the subsystem splitter comprises a emission wavelength filter.

16. The LIDAR system of claim 14, wherein the subsystem splitter comprises a polarization filter.
